(19) United States
(12) Patent Application Publication
(10) Pub. No.: US 2025/0380223 A1
(43) Pub. Date: Dec. 11, 2025

(54) UL Link Adaptation for Bandwidth Optimization

(71) Applicant: Parallel Wireless, Inc., Nashua, NH (US)

(72) Inventors: Nimrod Gradus, Givatayim (IL); Ori Shmuel, Herzliya (IL); Dor Shoham, Nes-Ziona (IL); Mirit Elyada Bar, Bnei Tzion (IL)

(21) Appl. No.: 18/737,948

(22) Filed: Jun. 7, 2024

Related U.S. Application Data
(60) Provisional application No. 63/494,900, filed on Apr. 7, 2023.

(51) Int. Cl. H04W 52/24; H04L 1/00; H04W 52/22; H04W 52/36

(52) U.S. Cl. CPC H04W 52/243; H04L 1/0003; H04W 52/225; H04W 52/365; H04W 52/367

(57) ABSTRACT

The current UL link adaptation algorithm in 5G and 4G was designed for maximization of the UE's spectral efficiency. Such algorithm that requires the UE for maximization of spectral efficiency keeps the MCS high toward a certain target SINR, however without consideration of the UL RB power limitation and utilization. Such implementation causes us to limit the UE's RB allocation, trying to reach the target SINR. Increasing the UL RB utilization is twofold, on the one hand, increase throughput as stated in Shannon's capacity formula, and on the other, increase of our SINR estimation accuracy. Motivated by those reasons, we design a new algorithm which tries to keep the UE to with enough available power to support the user required average RB allocation.

### CROSS-REFERENCE TO RELATED APPLICATIONS

The present application claims the benefit of priority under 35 U.S.C. § 119(e) to U.S. Provisional Patent Application No. 63/494,900, filed Apr. 7, 2023 and having the same title as the present application, which is also hereby incorporated by reference in its entirety. The present application also hereby incorporates by reference the following U.S. patents, each in their entirety: U.S. Pat. Nos. 10,257,008, 11,844,030, 11,129,240, 11,356,859; 11,490,272.

### BACKGROUND

Uplink link adaptation (ULLA) is the process wherein modulation and channel coding are selected. In ULLA, the base station (eNodeB in LTE or gNodeB in 5G) measures uplink channel quality and sends a message to a user equipment (UE) to use a specific modulation and coding scheme (MCS). Since the uplink channel quality is subject to change, averaged link quality is sometimes used. ULLA is further described in 3^{rd} Generation Partnership Project Technical Specification (3GPP TS) 36.300, and MCS is further described in 3GPP TS 36.213, which are hereby incorporated by reference each in its entirety.

### SUMMARY

In a first embodiment, a method is disclosed for uplink link adaptation (ULLA) in a telecommunication system, comprising: dynamically changing a user equipment (UE)'s target signal to noise ratio (SINR) based on the UE's available power and on the UE's resource block (RB) allocation needs, by: tracking, over a period of time, the UE's requested RB allocations and the UE's granted RB allocations; deriving the UE's average power level corresponding to the UE's granted RB allocations over the period of time; deriving the UE's available power level; comparing the UE's available power level with the UE's average power level; and determining to decrease the UE's target SINR when the UE's available power level may be lower than the UE's average power level, or to increase the UE's target SINR when the UE's available power level may be higher than the UE's average power level.

The method may further comprise sending a message to the UE reflecting an update to the UE's target SINR. The method may further comprise calculating average resource block allocation per UE using an infinite impulse response (IIR) filter. The method may further comprise receiving a power headroom report (PHR) from the UE that may be a report of headroom between estimated current UE transmit power and nominal UE transmit power; and deriving the UE's available power level from the power headroom report. The method may further comprise determining a power per resource block measurement. The method may further comprise comparing the UE's available power level with the UE's average power level together with a hysteresis term. The method may further comprise limiting a permitted value for the UE's target SINR to be equal to or less than a maximum target SINR. The method may further comprise deriving an expected throughput for lowering the UE's target SINR. The method may further comprise enabling the UE to select a higher throughput modulation coding scheme (MCS).

In a second embodiment, a non-transient computer-readable medium is disclosed comprising instructions which, when executed on a processor at a wireless telecommunication network base station, cause the base station to perform steps, the steps comprising: dynamically changing a user equipment (UE)'s target signal to noise ratio (SINR) based on the UE's available power and on the UE's resource block (RB) allocation needs; tracking, over a period of time, the UE's RB allocation needs; tracking, over the period of time, the UE's requested RB allocations and the UE's granted RB allocations; deriving the UE's average power level corresponding to the UE's granted RB allocations over the period of time; deriving the UE's available power level; comparing the UE's available power level with the UE's average power level; and determining to decrease the UE's target SINR when the UE's available power level may be lower than the UE's average power level, or to increase the UE's target SINR when the UE's available power level may be higher than the UE's average power level.

The wireless telecommunications network base station may be a Long Term Evolution (LTE) or 5G base station. The steps may further comprise sending a message to the UE reflecting an update to the UE's target SINR. The steps may further comprise calculating average resource block allocation per UE using an infinite impulse response (IIR) filter. The steps may further comprise receiving a power headroom report (PHR) from the UE that may be a report of headroom between estimated current UE transmit power and nominal UE transmit power; and deriving the UE's available power level from the power headroom report. The steps may further comprise determining a power per resource block measurement. The steps may further comprise comparing the UE's available power level with the UE's average power level together with a hysteresis term. The steps may further comprise limiting a permitted value for the UE's target SINR to be equal to or less than a maximum target SINR. The steps may further comprise deriving an expected throughput for lowering the UE's target SINR. The steps may further comprise enabling the UE to select a higher throughput modulation coding scheme (MCS).

### BRIEF DESCRIPTION OF THE DRAWINGS

FIG. 1 is a flowchart depicting an embodiment of the invention.

FIG. 2 is an architecture diagram, where the darker blocks are new mechanisms in the ULLA algorithm, in accordance with some embodiments.

FIG. 3 is a schematic diagram of 3GPP-compatible radio access network functional splits, in accordance with some embodiments.

FIG. 4 is a schematic diagram of an Open Radio Access Network (ORAN) network architecture, in accordance with some embodiments.

FIG. 5 is a schematic diagram of a multi-radio access technology (multi-RAT) ORAN network architecture, in accordance with some embodiments.

FIG. 6 is a schematic diagram of an ORAN-compatible network architecture, in accordance with some embodiments.

### DETAILED DESCRIPTION

The current UL link adaptation algorithm in 5G and 4G was designed for maximization of the UE's spectral efficiency. Such algorithm that requires the UE for maximization of spectral efficiency keeps the MCS high toward a certain target SINR, however without consideration of the UL RB power limitation and utilization. Such implementation causes us to limit the UE's RB allocation, trying to reach the target SINR. Increasing the UL RB utilization is twofold, on the one hand, increase throughput as stated in Shannon's capacity formula,

$$C = B {log}_{2} ( 1 + \frac{S}{N} )$$

and on the other, increase of our SINR estimation accuracy. Motivated by those reasons, we design a new algorithm which tries to keep the UE to with enough available power to support the user required average RB allocation.

UL link adaptation (ULLA) is the mechanism which selects and adapts the UE's UL allocation properties such as, MCS and RBs according to the UE's channel estimation. Such mechanism has two aspects, on the one hand it makes use of PHY inputs, e.g., SINR measurements, to choose the MCS to maintain a target BLER of 10%, and UE inputs, such as its power head room report to derive the UE's available power for calculation of the maximum number of RBs that can be allocated to the UE. On the other hand, another aspect of the ULLA mechanism is to select a certain target SINR for the UE to balance between the UE's pathloss and the UE's MCS/RBs. The way we control the UE's SINR, trying to achieve the target is by sending a transmit power command (TPC) to increase or decrease its power, resulting in higher or lower SNR, however also resulting in higher or lower power for RB allocation, as the UE's power for PUSCH transmission is defined by the following standardized formula,

$${PH}_{\text{?}} ( i , j , {q}_{\text{?}} \text{?} ) = {P}_{CMAX \text{?}} ( \text{?} ) - \{ {P}_{\text{?}} ( f ) + 10 {log}_{10} ( {2}^{\text{?}} \cdot {M}_{\text{?}}^{PUSCH} ( i ) + \text{?} ( f ) \cdot {PL}_{\text{?}} ( {q}_{\text{?}} ) + {Δ}_{\text{?}} ( i ) + {f}_{\text{?}} ( \text{?} ) \} \qquad [ dB ]$$

$$\text{?} \text{indicates text missing or illegible when filed}$$

And the maximum number of RBs is,

$$n R {B}_{max} = min \{ ⌊ {10}^{\frac{Pc max - {P}_{0 , PUSCH} - α \cdot PL - {Δ}_{TF} - f ( i )}{10}} \cdot \frac{1}{{2}^{μ}} ⌋ , {nRB}_{total}^{BW} \}$$

where:
Pcmax is the maximal power of the UE (which is reported by UE in the PHR);
P_{0,PUSCH} is the nominal power of the UE (p0−NominalWithGrant+p0_UE);
α·PL is the fractional pathloss where α is the RRC value signaled to the UE and PL is the pathloss estimation;
Δ_{TF} is a modulation and coding scheme offset;
f(i) is the power control adjustment state which is saved per each UE and implicitly handles the MCS power correction;
μ is the numerology which is 1; and

$$n R {B}_{total}^{BW}$$

is the total number of RBs in the BWP.

In this invention we address the tradeoff between the UE's SNR adjustment and power required for the RB allocation. For example, if we require the UE for the highest possible MCS then we shall comprise on the maximum number of RBs that we can we allocate to that UE. However, our main motivation is quite the opposite, we want to compromise on the UE's MCS but keeping a high number of maximum RBs which can be allocated. There are to main reasons for such initiative, first, the Shannon's capacity formula favors bandwidth and not SNR,

$$C = {log}_{2} ( 1 + \frac{S}{N} )$$

And second, we can achieve a much more accurate SNR estimation when we allocate more RBs. For these reasons, we suggest a ULLA algorithm which favors an increase in RB allocation rather than an increase in MCS.

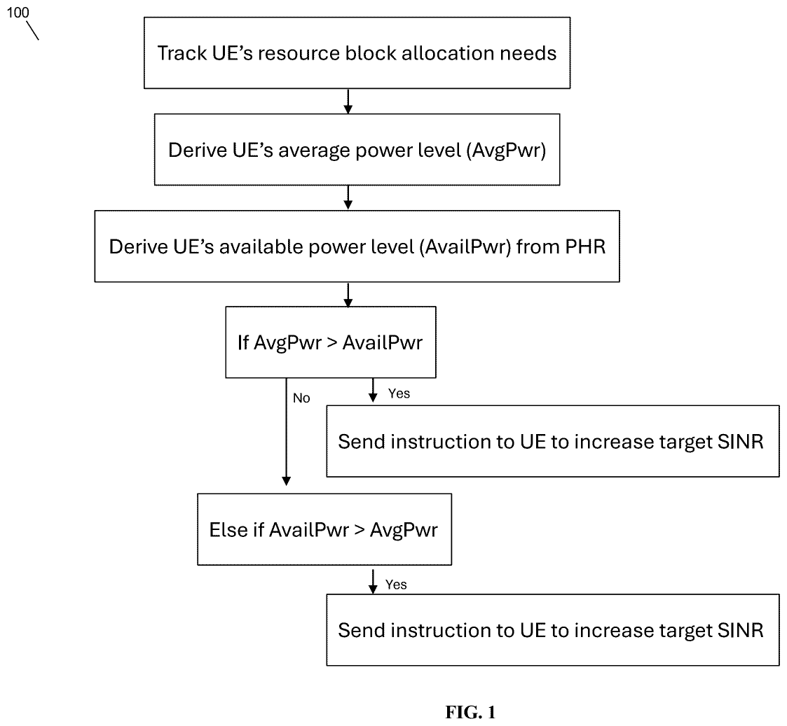

Our solution is to dynamically change the target SINR for the UE, based on the UE's available power and its need for RB allocation. We shall track the UE's average RBs required and given by the scheduler and derive the amount of power needed to support such allocation. If the UE's available power is lower than the required power then we shall decrease its target SINR, requiring the UE to lower its power and therefore allowing the UE to have a higher allocation. However, if the UE's available power is higher than the required power then we can increase its target SINR, increasing the UE's power and allowing the UE to reach a higher MCS.
FIG. 1 is a flowchart depicting an embodiment of the invention.

The relevant algorithm is found in pseudocode below, which is in accordance with some embodiments of the invention and also reflected in FIG. 1:

| | |
|---|---|
| 1. | Calculate average RB allocation per UE (IIR filter) |

| | |
|---|---|
| a. | AvgRB = ((1 − alpha)*AvgRB) + (alpha * (UE's current RB allocation)) |

| | |
|---|---|
| 2. | Receive PHR report |

| | |
|---|---|
| a. | PwrPerRB = MaxUePwr − PhVal − RbPwr |
| b. | AvailPWR = MaxUePwr − PwrPerRB |
| c. | If AvailPWR > (Power for Avg Allocation) + HystUp |

| | |
|---|---|
| i. | Target SINR = MIN(MaxTargetSINR,Target SINR + StepUp) |

| | |
|---|---|
| d. | else If AvailPWR < (Power for Avg Allocation) − HystDown |

| | |
|---|---|
| i. | If TPT({MCS,RBs},TargetSINR − 1) > TPT({MCS,RBs},TargetSINR) |

| | |
|---|---|
| 1. | Target SINR = MAX(MintargetSINR,Target SINR − StepDown) |

Where (1) is the average RB allocation IIR filter for the UE.

In (2), Upon receiving a power headroom report, we calculate the UE's available power (2.a, 2.b), and check if the UE's available power is higher than the power needed to support the UE's average RB allocation+hysteresis (2.c). Otherwise, we check the expected throughput of lowering the target SINR, opposed to keeping the current target SINR. If it is worth lowering the target SINR, then we decrease (2.d).

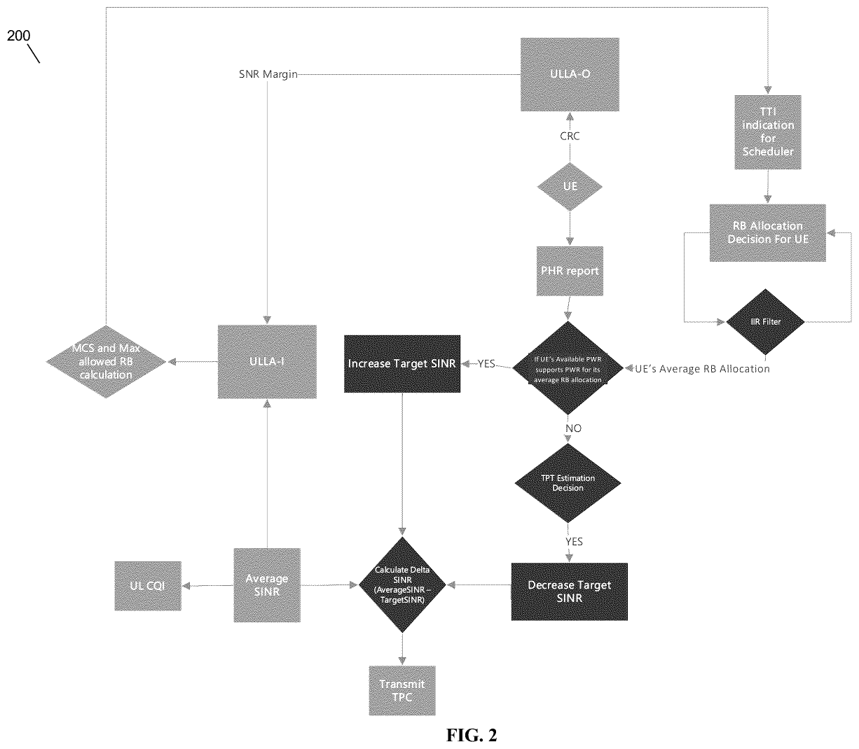

FIG. 2 is an architecture diagram, where the darker blocks are new mechanisms in the ULLA algorithm, in accordance with some embodiments.

The following describes how the present disclosure fits in with the rest of the wireless network.

Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

The first RAT may be 4G or 5G. The radio fronthaul interface may be Common Public Radio Interface (CPRI) or Enhanced Common Public Radio Interface (eCPRI). The second RAT may be 2G or 3G, and The radio fronthaul interface may be Common Public Radio Interface (CPRI) or Enhanced Common Public Radio Interface (eCPRI). The first and the second functional RU may be colocated on a single physical device and virtualized to operate as separate processes. The first and the second functional RU may be instantiated as virtualized containers.

The multi-RAT non-RT RIC may be coupled to a network operator service management and orchestration (SMO) functionality. The method may further comprise a multi-RAT central unit control plane (CU-CP) and multi-RAT central unit user plane (CU-UP).

### Radio Unit Functional Splits

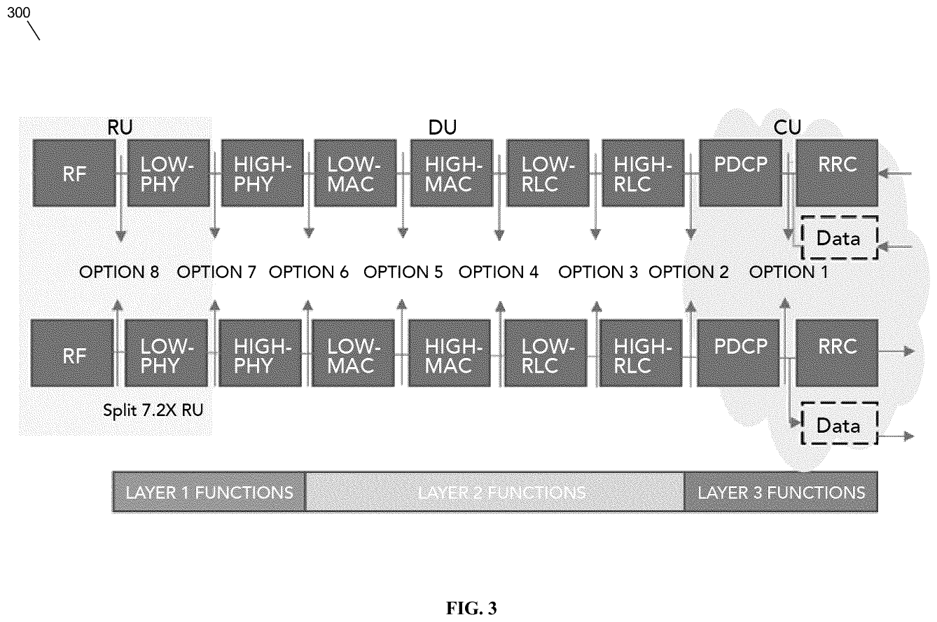

FIG. 3 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

In some embodiments, the ULLA functionality and various other functionality described herein may be present in the high PHY. In some embodiments, various functionality may be split among the low PHY and the high PHY and may be distributed accordingly among the RU and the DU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

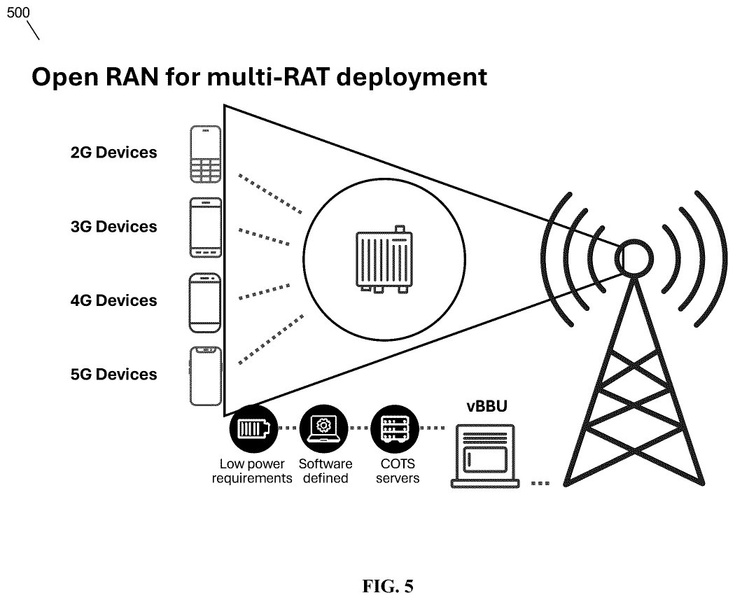

When the RAN functional split architecture (FIG. 5) is fully virtualized, CU and DU functions runs as virtual software functions on standard commercial off-the-shelf (COTS) hardware and be deployed in any RAN tiered datacenter, limited by bandwidth and latency constraints.

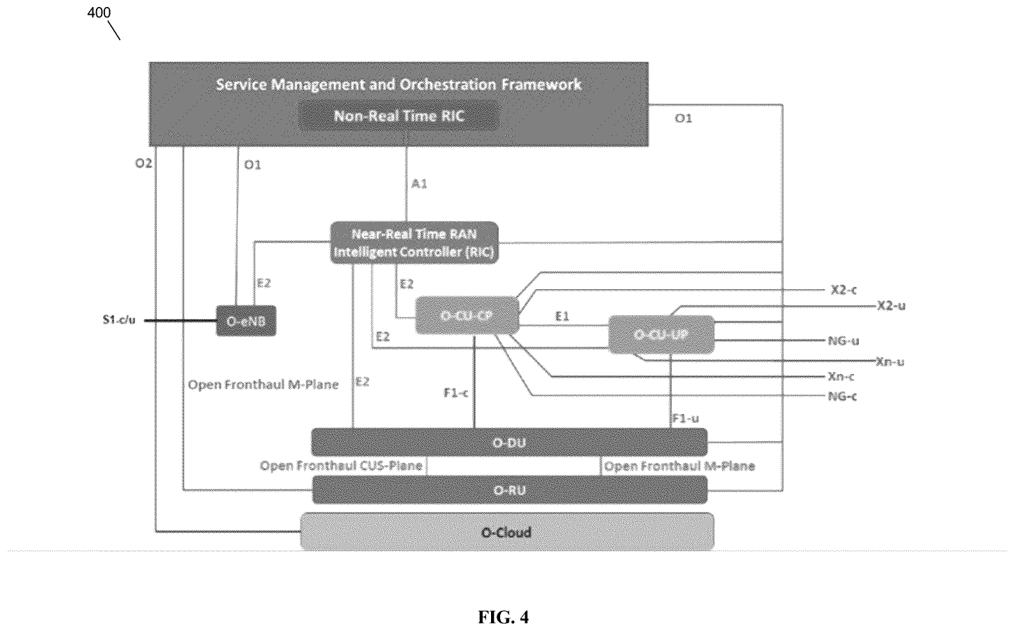

FIG. 4 is a schematic diagram of an Open RAN 4G/5G deployment architecture, as known in the art. The O-RAN deployment architecture includes an O-DU and O-RU, as described above with respect to FIG. 2, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU.

FIG. 5 is a schematic diagram of a multi-RAT RAN deployment architecture, in accordance with some embodiments. FIG. 4 shows a radio tower with a remote radio head (RRH) supporting multiple RATs, 2G/3G/4G/5G, but without requiring four generations of radio base stations on the tower. Instead, one or more software-upgradable, remotely configurable base stations is coupled to radio heads and filters that are able to operate on the appropriate frequencies for 2G, 3G, 4G, and 5G RATs. The multiple BBUs located at the bottom of the tower in the prior art have been replaced with one or more vBBUs, baseband units that are rearchitected to use modern virtualization technologies. FIG. 5 can be enabled using a technology like CPRI or eCPRI, which enables digitization and transfer of radio I/Q samples for further processing at a BBU or vBBU.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

In some embodiments, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

In some embodiments, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

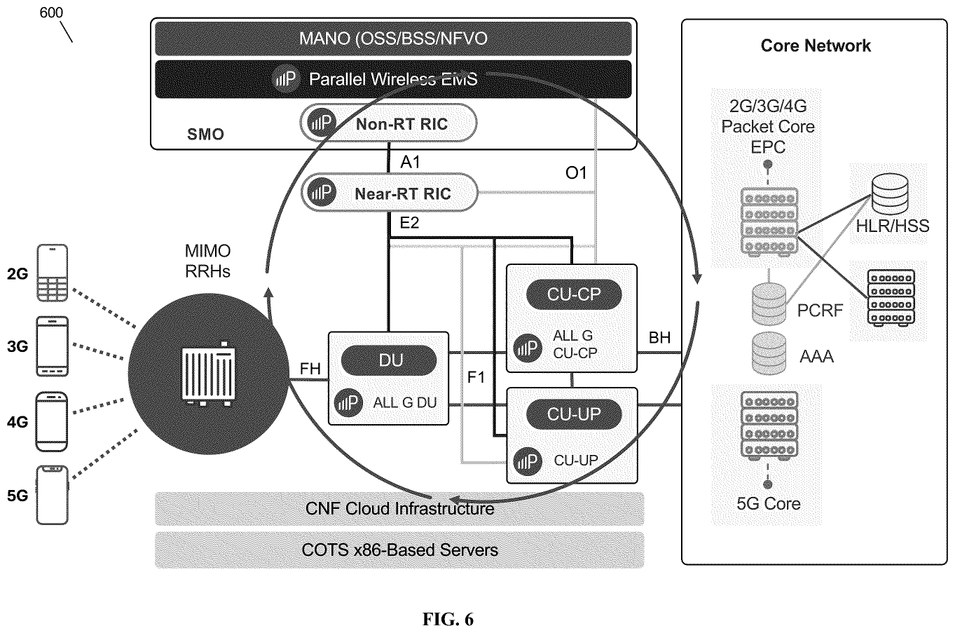

FIG. 6 is a further schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G. The all-G RRH plus DU/CU, i.e., the RAN portion of the diagram, are understood to be the components used to provide the functionality described hereinabove.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is connected to an appropriate core network node. Different protocols other than S1AP, or the same protocol, could be used, in some embodiments.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application. In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for uplink link adaptation (ULLA) in a telecommunication system, comprising:
dynamically changing a user equipment (UE)'s target signal to noise ratio (SINR) based on the UE's available power and on the UE's resource block (RB) allocation needs, by:
tracking, over a period of time, the UE's requested RB allocations and the UE's granted RB allocations;
deriving the UE's average power level corresponding to the UE's granted RB allocations over the period of time;
deriving the UE's available power level;
comparing the UE's available power level with the UE's average power level; and
determining to decrease the UE's target SINR when the UE's available power level is lower than the UE's average power level, or to increase the UE's target SINR when the UE's available power level is higher than the UE's average power level.

2. The method of claim 1, further comprising sending a message to the UE reflecting an update to the UE's target SINR.

3. The method of claim 1, further comprising calculating average resource block allocation per UE using an infinite impulse response (IIR) filter.

4. The method of claim 1, further comprising receiving a power headroom report (PHR) from the UE that is a report of headroom between estimated current UE transmit power and nominal UE transmit power; and deriving the UE's available power level from the power headroom report.

5. The method of claim 1, further comprising determining a power per resource block measurement.

6. The method of claim 1, further comprising comparing the UE's available power level with the UE's average power level together with a hysteresis term.

7. The method of claim 1, further comprising limiting a permitted value for the UE's target SINR to be equal to or less than a maximum target SINR.

8. The method of claim 1, further comprising deriving an expected throughput for lowering the UE's target SINR.

9. The method of claim 1, further comprising enabling the UE to select a higher throughput modulation coding scheme (MCS).

10. A non-transient computer-readable medium comprising instructions which, when executed on a processor at a wireless telecommunication network base station, cause the base station to perform steps, the steps comprising:
dynamically changing a user equipment (UE)'s target signal to noise ratio (SINR) based on the UE's available power and on the UE's resource block (RB) allocation needs;
tracking, over a period of time, the UE's RB allocation needs;
tracking, over the period of time, the UE's requested RB allocations and the UE's granted RB allocations;
deriving the UE's average power level corresponding to the UE's granted RB allocations over the period of time;
deriving the UE's available power level;
comparing the UE's available power level with the UE's average power level; and
determining to decrease the UE's target SINR when the UE's available power level is lower than the UE's average power level, or to increase the UE's target SINR when the UE's available power level is higher than the UE's average power level.

11. The computer-readable medium of claim 10, wherein the wireless telecommunications network base station is a Long Term Evolution (LTE) or 5G base station.

12. The computer-readable medium of claim 10, the steps further comprising sending a message to the UE reflecting an update to the UE's target SINR.

13. The computer-readable medium of claim 10, the steps further comprising calculating average resource block allocation per UE using an infinite impulse response (IIR) filter.

14. The computer-readable medium of claim 10, the steps further comprising receiving a power headroom report (PHR) from the UE that is a report of headroom between estimated current UE transmit power and nominal UE transmit power; and deriving the UE's available power level from the power headroom report.

15. The computer-readable medium of claim 10, the steps further comprising determining a power per resource block measurement.

16. The computer-readable medium of claim 10, the steps further comprising comparing the UE's available power level with the UE's average power level together with a hysteresis term.

17. The computer-readable medium of claim 10, the steps further comprising limiting a permitted value for the UE's target SINR to be equal to or less than a maximum target SINR.

18. The computer-readable medium of claim 10, the steps further comprising deriving an expected throughput for lowering the UE's target SINR.

19. The computer-readable medium of claim 10, the steps further comprising enabling the UE to select a higher throughput modulation coding scheme (MCS).
